(19) United States
(12) Patent Application Publication
(10) Pub. No.: US 2016/0059622 A1
(43) Pub. Date: Mar. 3, 2016

(54) Life-like, simulated, animal pelts and hides and method

(71) Applicant: Tricia L. Orcutt, Mauldin, SC (US)

(72) Inventor: Tricia L. Orcutt, Mauldin, SC (US)

(21) Appl. No.: 14/121,377

(22) Filed: Aug. 26, 2014

(51) Int. Cl. B44F 9/00

(52) U.S. Cl. CPC B44F 9/00

(57) ABSTRACT

A high-quality, simulated, life-like animal pelt produced by selecting a specimen and producing a detailed digital photographic array of all body areas and body parts of the pelt and merging these images to a single life-like image of the specimen. Then transferring this image to a transfer material adapted to transfer the image using dye sublimation technology in conjunction with selected, flocked base. Cutting and reassembling the flocked image and adding individual realistic body appendages (ear flaps, mane, and the like) and additional, non-flock, texture enhancing material (pile material or natural material) to yield a finished product.

### RELATIONSHIP TO OTHER APPLICATION AND PRIORITY

This United States patent application claims priority of U.S. Provisional Patent Application 61/959,667 filed Aug. 29, 2013 which provisional application is hereby incorporated in its entirety by reference.

### FIELD OF THE INVENTION

The invention is directed to a method of making life-like/life-size, simulated pelts, skin, hides, or fur and to life-like, synthetic pelts, skin, hides, or fur produced by following such a process.

Herein after, skins and pelts, according to custom are used interchangeably and include such other terms as furs and hides. More specifically, the invention is directed to a method of making life-like, simulated pelts and hides that have a strong, visual textural element and to life-like/life-size simulated pelts and skins, having a strong, visual textural component produced by such a method. Finally, the invention is directed to a method to produce life-like simulated pelts and skins furs with fine, accurate detail of coat markings and features and to life-like simulated pelts and hides produced following such a method.

### BACKGROUND OF THE INVENTION

Virtually from the dawn of recorded history, animal pelts and skins have played a significant role in human life. Initially, pelts and skins were a useful by-product of hunting. Records tell the story of the use of such animal products for shelter and protection (clothing). Ancient rulers used, and at least in ceremonial costume, today's royalty continues to use animal pelts as status symbols. Ermine pelts continue to be part of ceremonial robes for European monarchs, and even the pelt of the lowly rabbit has become a favorite for hats, coats, and glove linings. Beaver pelts became a virtual source of currency in settling the interior of North America, and the popularity of beaver hats in Europe led to significant conflicts between and trappers/explorers in the early exploration of the interior of North America.

The popularity of animal fur has never died, but it has waxed and waned. In recent years, pelts again have become increasingly popular. Popularity includes pelts “harvested” from animals grown on “fur farms” for the primary purpose of harvesting pelts, such as mink farms. Hides, as a by-product of hunting in the United States, are processed into a variety of practical and novelty items from gloves to “old west ware” popular with some children. As is well recognized, animal welfare/animal rights activists in the United States and world-wide continue to voice strong objections to sport hunting/trophy hunting and fur farming. In addition, conservation and preservation groups have added their voices to the animal rights/animal welfare groups at least in the interest of protecting endangered species and the habitat on which they depend. This has led to concerted and effective efforts to protect exotic species, many of which are “prized” animals in pelt/skin trade. The international efforts to reduce or limit taking many species has been more-or-less successful. Unfortunately, regulation has significantly increased poaching representatives of protected species and black market sale of the pelts and other body parts (ivory is a tragic example). The available supply of many foreign, exotic specimens has decreased to near zero, yet a demand for traditional uses and new uses continues to grow. A reasonable solution to sacrificing animals, reducing population sizes to dangerously low levels, and to dampening the poaching/black market profiteering is found in producing truly life-like, simulated pelts and skins that are as suitable as natural pelts and skins for many commercial purposes.

Artificial or simulated pelts and skins are not a new concept, and are reasonably common for some products in retail markets today. At one time, elegant hand embroidered gowns, robes, jackets as well as decorative items featured images of a variety exotic birds and mammals. Neither coat pattern/color nor texture lent itself to a life-like image, the relative importance of which varied with the article and individual, but rarely were these attributes considered insignificant in judging the item. With mechanization, many of such items became larger and comparatively more detailed, but achieving truly life-like texture and detail was rare.

The textile, fashion, and interior design industries have contributed extensively both to increasing the demand and meeting the demand for materials with life-like images of a wide variety of animal skins and pelts to manufacture a variety of commercial goods from shirts to sheets and carpets to upholstery fabrics. Both natural and synthetic fibers could be woven into a variety of specialized fabrics. Both could be dyed to produce life-like coat color patterns, but texturing remained rather ineffective. In recent years, technology has opened many opportunities for more effective texturing of many fabrics and materials for a variety of purposes.

### PRIOR ART

Much of the prior art in the broadest sense is related to the growth and advancement of textile technology and the advent and growth of the use of synthetic fibers in a multitude of products for a variety of purposes. Although the claimed invention must be included as a beneficiary of this technology, a detailed discussion of the growth of textile manufacturing is far beyond the scope of the claimed invention and is not part of the following discussion of relevant prior art.

Artificial fur, or fur like material is not a new concept of textile products. Its growth follows the new, synthetic fibers, technology in dyeing, and weaving and textile manufacturing. An initial important feature or characteristic of artificial fur was the tactile similarity between natural fur and artificial fur, a feature of great significance in the international, “fur” sales industry. Okmoto, Yoshida, and Kurata, U.S. Pat. No. 4,390,572 issued Jun. 28, 1983, disclosed a fur-like sheet material with numerous superfine pile fibers. Pile fibers are synthetic and very fine, 0.0001 to 0.4 denier. The fibers are crimped and are formed into bundles. The crimps of the pile fibers are generally in phase within each bundle. Yamagata and Sakai, U.S. Pat. No. 4,415,611 issued Nov. 28, 1983 disclose an artificial fur made from a pile cloth in which the pile fibers have a first layer of guard hair with longer, thicker, tapered fibers compared with the second group of shorter, under fibers. The two fibers are grouped in bundles in the ground construction. Conventional dyeing is suggested for coloring the “fur.”

Matsui, Okamoto, and Osagawa, U.S. Pat. No. 4,461,791 issued Jul. 24, 1984, claimed fur-like articles with pile having differences in color or fineness. As, in the '611 patent (above), the pile comprised longer, “tougher” guard hair and softer, shorter hair. The pile varies three-dimensionally in at least one of the three following characteristics: color, length, or texture. The fibrous structure with piles fixed to a support is rotated; the piles rises in response to centrifugal force and contacting a treating liquid for fibers which is contained in a rotatory container and forms a cylindrical interface which ultimately explains variation in at least one of the color, length and fineness attributes of the piles.

Some artificial fur has been developed specifically to simulate a particular species of animal. Matsui, Okamoto, and Naruse U.S. Pat. No. 4,729,913 disclose and claim a chinchilla-like artificial fur. The artificial fur comprises a base or substrate fabric with piles on one surface. The piles comprise fine, short, densely packed under hair and slightly longer, coarse, far less densely packed guard hairs. The piles may have length-wise color variation. Commercially, the tactile attributes are very important and the described artificial fur is claimed to be superior in this attribute. In yet another version of fur-like material, Shibukawa and Yajima in U.S. Pat. No. 5,049,429 issued Sep. 17, 1991 describe a fur-like pile fabric comprising guard hair-like fibers (relatively long and coarse) and down hair-like fibers that are softer and shorter than the guard fibers. The guard hair fibers in a unit are adhered in a brush, which generates the feel (texture) and appearance of natural fur.

Manne in U.S. Pat. No. 5,329,680 issued Jul. 19, 1994 and titled, “Process for Manufacturing Felted Products,” describes and claims a process to produce highly personalized, individualized reproductions of works of art on various fabric bases. The process involves needle punching a predetermined array of natural and synthetic fibers in a specific pattern on a felt base. Sections of the base are shaped and trimmed and ultimately combined to yield the design (art work). Depth (a three dimensional image) is produced by placing selected sections on two or more thickness of the felt material so as to actually create the third dimension which can be enhanced by color and shape.

McCulloch, in U.S. Pat. No. 5,981,021 entitled “Transfer Printing Flocked Fabric” and issued Nov. 9, 1999, claims transfer printed, flocked fabric and a method. Unlike the above cited patents, the '021 patent does not depend on pile for color or texture, but on flocking technology. The fabric in the '021 patent includes a textile substrate having raised nylon fibers on the substrate, a black pigmented adhesive adhering the nylon fibers to the substrate and dispersed dye distributed in a pattern in the upper portions of the nylon fiber and the upper portion of the nylon fibers being colored only by the dispersed dye, thereby yielding a dark, crock-fast colored print. Van Vetchen and Hultine disclose in practical detail and theory a process for forming a three dimensional pattern on a substrate using electrostatic forces placed on dielectric fibers and an electrostatic image written on a product substrate or onto a transfer surface. U.S. Pat. No. 6,756,174 issued Jun. 29, 2004. The process is used to assemble three dimensional structures composed of fibers or of rod shaped components in a matrix of a second dielectric material.

Huang and Chen disclose and claim a thermal sublimation printer system and method. The system is capable of precisely cutting printed material. U.S. Pat. No. 8,466,939 issued Jun. 18, 2013.

Flocking and sublimation dye printing are well known technologies in the textile and related industries. The invention claimed in this Application uses the technologies, or products produced from specific, unique applications of these technologies but does not claim the technologies per se. Understanding the basic technologies is fundamental to understanding and appreciation of the claimed invention. Thus, a brief review of both technologies is included as prior art.

Flocking and the use of resin glue to bond natural fibers to fabrics traces back to about 1,000 BC in China. In the Middle Ages, fiber dust was spread on glue coated fabrics to create decorative materials in Germany, and in France, during the reign of Louis XIV flocked wall coverings became popular.

The flocking process is not markedly complicated. The material to be flocked (the base or fabric) is selected as appropriate. A surface is coated with a coat of adhesive (glue) appropriate for the flocking material, the base material, and the anticipated use, and the flocking material is distributed over the surface of the material. It is desirable to have the minute flock particles (fibers) standing on one end, vertical to the surface of the glued material. This is accomplished variously by electrically charging flock fibers before spreading them on the grounded material to be flocked or by various physical/mechanical means (beater bar/gravity, spraying, or transfers).

Flocking material is described by the type of fiber, natural (cotton) or synthetic (rayon, acrylic, and polyester, for example) and the length of the fiber: random cut or precision cut. Generally, only synthetic fibers are precision cut. The diameter of individual fiber strands is only a few one thousandths of a mm; fiber fineness is commonly expressed in denier units, a weight equivalent measure common in the textile industry. Fiber length varies from about 0.25 to 5 mm. Both fiber length and diameter (denier) affect texture.

Although an ancient technology, flocking remains a useful technique for an amazing variety of applications. The continued use is, obviously, closely associated with both new techniques and new products.

Flocked materials are used for purposes as varied as artificial snow (flocking) on Christmas trees, anti-glare surfaces in automobiles, designs on fabrics, and to make light-tight containers for photographic film, Over 500 US patents have been issued for various flock uses, products, and methods. Diversity of patent product ranges from, for example, a spherical bearing that includes a bearing liner that includes self-lubricating particles; the particles include flocked polytetrafluoroethylene particles and graphite fibers (U.S. Pat. No. 3,932,008, issued Jan. 13, 1976) to a method and apparatus to impress a pattern on flocked materials (U.S. Pat. No. 5,510,143 issued Apr. 23, 1996), a flocked automobile visor to reduce glare (U.S. Pat. No. 5,951,091 issued Sep. 14, 1999), and an applicator for mascara (U.S. Pat. No. 5,765,573, issued Jun. 16, 1998).

Transferring a photographic image to a flocked material is an essential step in the claimed invention, but the transfer process, sublimation (phase transfer) or dye sublimation, is not claimed per se. Sublimation describes the transition of a substance, such as water, from a solid state (ice) to a gaseous state (water vapor) without passing through the intermediate state, liquid or the reverse, from gas to solid, without the liquid state or phase. Dye sublimation follows the same pattern: a solid dye, when exposed to appropriate conditions of heat and pressure changes to a gas, impregnates a fiber imparting (dyeing) the fiber and returning to the solid state.

In the present invention, a digital, colored photograph represented by the digital master file, which usually comprising a plurality of sections, is transferred in the form of dye particles to a heat sensitive image transfer sheet. The image transfer sheet, under very specific conditions of heat and pressure, is passed over a flocked material at least once, and commonly several times to impart a specific color by converting the dye particles in the “gel” to a gaseous form and the gas impregnating the flock particles, thereby coloring it in a specific fixed color. The pattern of colors in the “gel” is transferred to the flock material. In addition the technology must match basic properties of the flock material with properties of the dye to ensure durable, accurate reproduction of the various colors, shades, and hues. Following completion of the dye transfer, the flocked material is cured, cooled, cleaned, and additional texturing materials may be fixed to the base material to enhance the final product.

### Goals and Objectives

A first goal and objective of the invention is a simulated animal pelt that is life-like/size in appearance and in terms of coat color, texture, and characteristic markings; such simulated pelts and skins shall include, but not be limited to any canine species, any feline species, any non-domestic ungulate species, any domestic ungulate species, any domestic mammal, and any animal recognized in the United States by one or more states as a big game species.

A second goal and objective of the invention is a simulated animal pelt that is highly durable for its intended use.

A third goal and objective of the invention is a simulated animal pelt in which the ear flaps are oriented such that the natural texture of the ears is maintained with respect to the full pelt to ensure a life-like appearance.

A fourth goal and objective of the invention is a simulated animal pelt in which the mane (if any) and tail are specially manufactured such that the coat pattern of the pelt and unique texture of the mane and tail are maintained to ensure a life-like appearance.

A fifth goal and objective of the invention is a life-like, simulated, animal pelt appropriate for a variety of uses that does not injure living animals as a result of its manufacture.

A sixth goal and objective of the invention is a method by which advanced, digital photographic techniques are used with flocking technology including the use of other texturing materials and sublimation dye printing to produce a life-like, simulated. animal pelt that may be used for a variety of purposes.

These and other goals and objectives can be satisfied by selecting animal pelts based on species and gender that are available from various sources including museums, private collectors, and others without harming additional animals; after careful examination of the pelt for damage and defects and careful repair of such, the entire pelt is photographed using high resolution, digital technology and photographing the full pelt in relatively small sections or areas; next, the photographs are reviewed, edited and ultimately merged into a single image (file), using proto-technology this high resolution photograph is used to produce a transfer sheet gel that is impregnated with heat and pressure sensitive dyes; using sublimation dye printing technology he image is transferred to flocked material to which other texture enhancing materials can be included to render a truly life-like, simulated animal pelt, without harming any living animal; the flocked material is selected considering the base on which the product is formed, the flocking fiber best suited to achieve superior results and compatibility with appropriate adhesives.

### BRIEF SUMMARY OF THE DRAWINGS

FIG. 1A illustrates a simulated pelt of a zebra or similar large animal with a highly unique coat pattern; eye slits, mane, ear flaps, and tail are included. The entire body is produced on flocked material.

FIG. 1B illustrates a simulated pelt of a large member of the cat family, such as a cheetah; the body includes both flocked areas and areas in which texture is achieved with pile material.

FIG. 2 illustrates the details of making and positioning the ear flaps.

FIG. 3 illustrates a method of making and positioning eyelid and eyelash assembly.

FIG. 4 illustrates a first method of making the mane hair assembly insert.

FIG. 5A illustrates a second, looping method of making the mane hair insert.

FIG. 5B illustrates the tail assembly for a zebra.

FIG. 5C illustrates steps in making assembly of FIGS. 5A and 5B.

FIG. 5D illustrates one pattern of trimmed hair using aternate assembly method.

FIG. 6A illustrates completed master file with over lap areas deleted.

FIG. 6B illustrates master file showing over lap areas of cells.

### EXAMPLES OF BEST MODES

Regardless of the ultimate use of the initial pelt or skin product manufactured, the manufacture process or method to produce a very high quality, life-like, simulated, animal pelt or skin remains the same. The process involves highly technical equipment and skills coupled with significant artistic skills and capabilities, based on an understanding of the natural material to be simulated. It also requires consideration of animal welfare and humane treatment of animals as well as conservation concerns and legal issues at state and federal levels, plus international agreements limiting trade and shipment of many animal products and live animals. Much of the concern arises from endangered species concerns, and simulation of pelts is one acceptable alternative to the use of actual animal specimens.

The first step in the process is selection of both the species and gender of the specimen to be simulated. Selection of the species as part of the first step requires little explanation. Frequently it is a matter of personal choice. Coat color and pattern frequently are the major factors. Potential use of the simulated pelt material are recognized, important considerations, particularly in the fashion and interior design design industries. Gender selection may be as, or more important than selection of the species. Not only are there marked differences in size, but of greater significance coat patterns, including coloration and complexity, which differ between males and females of many species. The male's coat markings, color, size, and even shapes of markings are more obvious and bolder than females of a given species. Females commonly display coat patterns and color that blend in with the natural background of the normal habitat of the species; however, females cannot be ignored because at any time the more subdued female coat patterns may become the rage of the fashion or interior decorating interests, in which the simulated materials currently find extensive use.

Following selection of the species and gender required by the designated use of the simulated product, the next step is finding a very high quality specimen of the actual pelt or skin. It should be noted that with some species particularly rare foreign specimens, securing a specimen may be virtually impossible, thereby requiring a major modification of the project, selecting an alternative.

It is assumed that the specimen will not be harvested from the wild, although preservation of trophy specimens through simulations is not unreasonable. For most domestic animals, specimens can be found in many public and private museums and collections, including sportsman clubs and conservation groups may have appropriate specimens. Considering the use of the specimen in producing the simulation does not harm the specimen, let alone destroy it; arrangements may be made to use at least certain samples. In some areas, local taxidermists may provide either specimens, or at least contacts. Some may have specimens from a variety of animals that had been part of their displays. Conservation and state and federal wildlife agency officials may at least be sources of information as to availability of specimens and may have samples used in teaching activities and programs. The law regulates possession and sale of wild animals and products.

Specimens of non-domestic, wild game animals present additional conditions that must be considered. Importing and possessing wild animals or their pelts, skeletons, tusks and the like is strictly regulated, and for many species prohibited. For any species, before any specimen is used as a simulation specimen, or before any specimen is borrowed (regardless of payment) or purchased be certain that the individual providing the specimen can legally possess it and allow its use.

The third step in the process of producing a high quality, life-like simulated pelt is photographing the specimen. This is far more than a snap shot of the pelt. Subsequent processing favors the use of the highest quality digital photographic equipment: camera, lenses, films, lighting, and print processing. The specimen must be photographed in a variety of sections, not necessarily as specific body units, such as head, shoulders, chest, and so forth; ultimately, multiple files are merged into a single, digital image file of the specimen, and this digital image file must be of such high quality that enlargement to life-size will not reduce details or introduce blemishes. Experience and technical expertise in photography and the use of photo-editing software are essential, but even the most skilled technicians must introduce an element of trial and error (exposure, shutter speed versus aperture and depth of field, lighting and filters and printing materials and dyes, are obvious variables to be evaluated) in producing this fundamental element of the final simulation product.

The following provides details of examination of the specimen pelt to ensure the best possible photographs from which the simulated pelt will be produced. Rather than present the material at specific points in the process, efficiency suggests that it be combined at this point, although other points are equally appropriate. The information stresses how the master image file will be prepared for transfer to the simulated pelt and various steps and processes that must be considered prior to or as part of the photographic process itself.

Prior to the taking photographs, the entire specimen must be examined to identify any defects, faults, or damage, and as far as possible to remedy these. In addition the pelt must be cleaned to highlight the true colors and shades that comprise the pattern of the coat. Then the coat must be groomed such that the grain and texture of the entire coat accurately reflect the natural state. This requires an element of expertise in understanding and recognizing the elements that yield the pattern of the coat, and how grooming may enhance the specimen and in part may also overcome defects and damage to the specimen. This final preparation focuses on preparing the coat such that the color, including shade variations, shapes, and distribution of shapes are characterized accurately in the simulation. A final element included in this effort is preparation of the specimen to optimize the texture (three-dimensional aspects of the full coat) to yield the most natural, life-like simulated image.

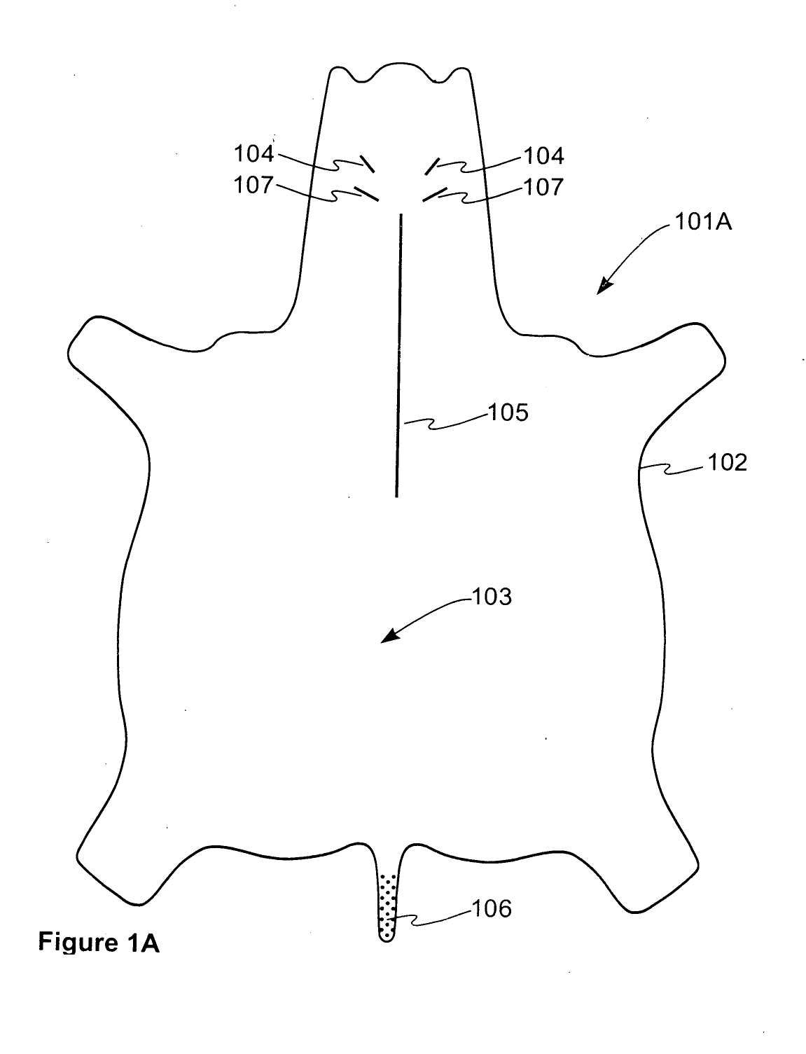

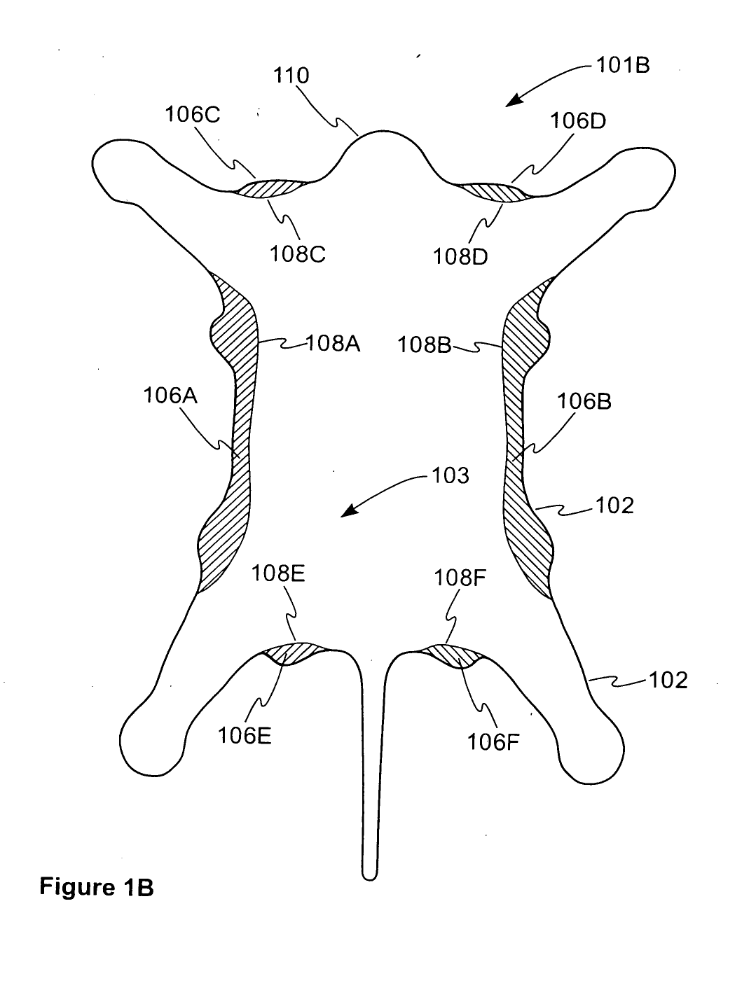

FIGS. 1A and 1B illustrate the different sections of the simulated, life-like animal pelt that may be represented by different textures. FIG. 1A is a generalized outline (body profile, top view) of a zebra that also characterizes a larger, different animal, such as a giraffe simulated pelt. FIG. 1B is a similar, generalized view of a large cat (nearly any feline): tiger, cougar, leopard, or cheetah, but not a male lion, the mane typical of the male is absent.

In FIG. 1A, the simulated zebra pelt 101A comprises a single body area 103 with a continuous outline or perimeter 102. The zebra, in addition to having a very distinctive coat pattern and texture 103 has four other specific areas that are separately treated because they are unique and thus important to the life-like appearance of the simulated pelt: eye slits 104, the mane 105, the tail 106, and the ear flaps 107. Thus the simulated zebra pelt comprises five elements representing four differentially textured areas or segments within a continuous perimeter. In contrast, FIG. 1B, representing a large cat, has only two elements that are critical to the life-like, simulated pelt. The simulated pelt must have a limiting perimeter 102; however the perimeter comprises up to six areas (three pairs of areas) that differ from the body as a whole 103 and from sections of the perimeter that are part of the coat pattern and texture as a whole 103 and are similar among all six sections. For convenience, members of these pair of perimeter sections are identified as the lateral edges 106A and 106B, the ventral shoulder section 106C and 106D, and posterior section 106E and 106F. For convenience, each member of each six separate sections 106A/B, 106C/D, and 106E/F is separated for illustrative purposes by an interior boundary line, 107A/107B; 107C/107D; and 107E/107F. As illustrated, the boundary lines 107A through 107F are distinct. In the specimen and in the simulated pelt, these lines, or the separation they represent are slightly indistinct, but regardless, the distinctions are real.

As explained in detail below, a significant portion of the main body element 103 may be produced using flocked material and sublimation dyeing techniques. As understood by one skilled in the art, the flocked material has a treated, or flocked side or surface and a second, or underside that is untreated. The flocking process is described in greater detail below.

Functionally, flocking comprises adhering a dense layer of minute particles of material, such as artificial fibers to the upper surface of the material. The adhered material is permanently adhered to the material and is a wear resistant surface. In addition, specific flocking material is reactive to dyes using sublimation dying technology; thereby the coat pattern, texture, and color patterns of the ear flaps 107 are also frequently separately manufactured (although with some species they are appropriately included as a part of the flocked material. Even when made using the flocking process, ear flaps may be photographed separately to produce ear flaps that replace those in the images of the head. The process is described below.

With the specimen fully examined and repaired/restored if necessary and feasible, and cleaned and with the preceding information as to basic aspects of the specimen pelt and photographic considerations related to them, the next step is taking the photograph(s) (photo-digital images) that are merged and photo-digitally edited to yield the master image file. The master image file represents the full specimen; however, in terms of producing the final, high quality, simulated artificial pelt, only those images to be processed using sublimation dyeing technology require critical technical control.

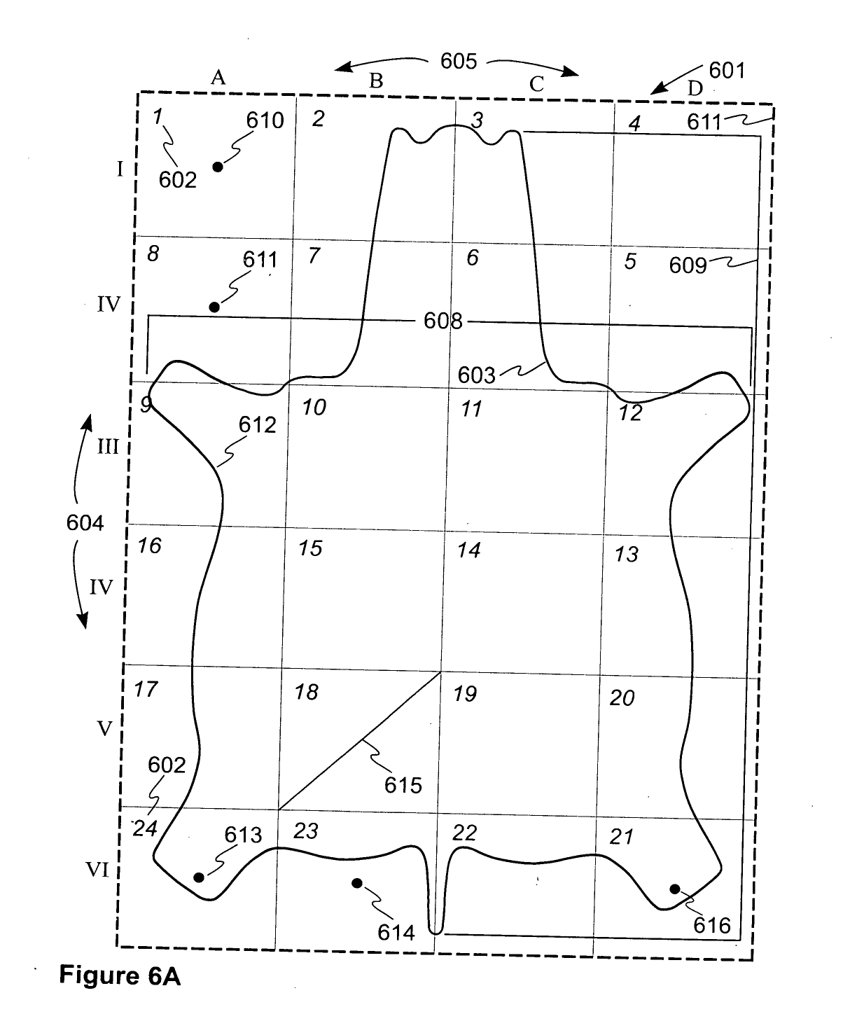

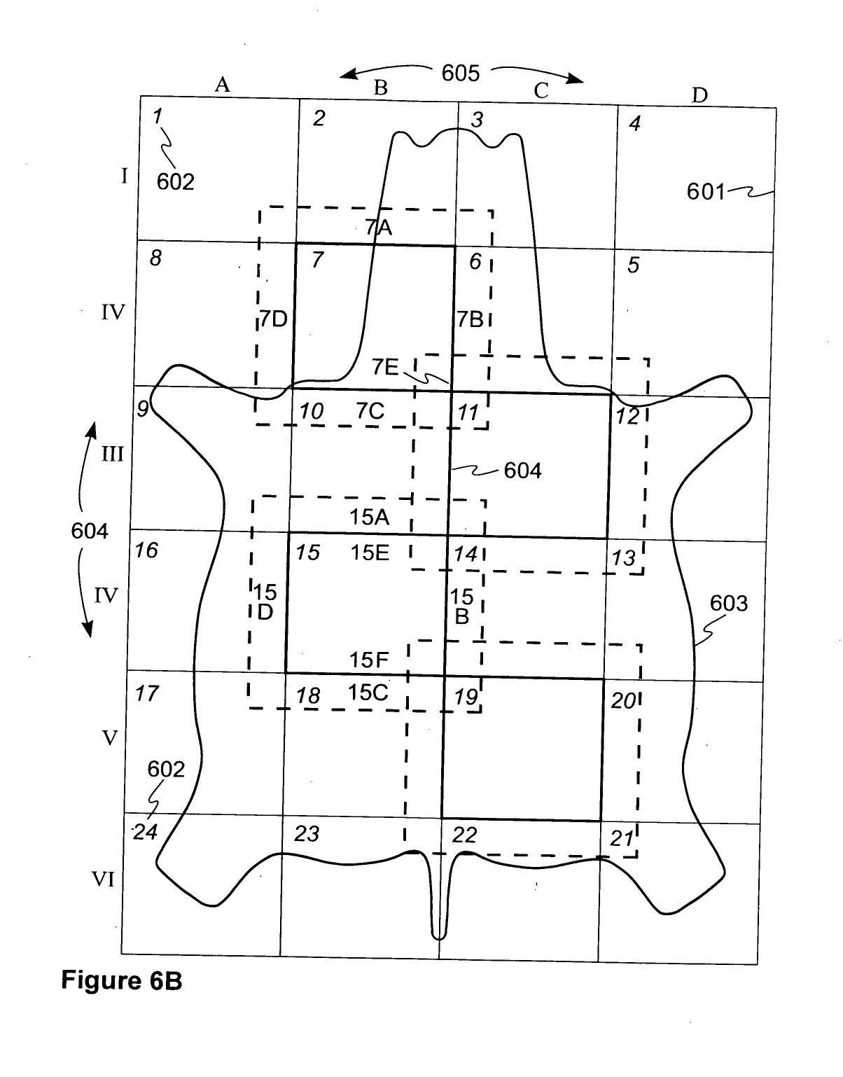

To produce the master image file 601, FIG. 6A the final, life-like/life-size image of the specimen (pelt) to be transferred to the finished product material, the specimen (pelt) is placed on very stable, support table with the camera securely positioned above it at a pre-specified distance with the lens or photo-plane parallel to the pelt (specimen) surface. The specimen pelt is photographed in a grid pattern, with each cell of the grid comprising a file. The master image file comprises lateral rows 604 and longitudinal columns 605. Rows 604 are numbered 1-VI and columns 605 lettered A through D, 6 rows and 4 columns, by way of illustration, not limitation. The individual cells are numbered in the upper right hand 602 corner in a serpentine pattern 1-24. The grid is normally rectangular, but not necessarily square, and the cells similarly rectangular, but not necessarily square. Cells are uniform in size and shape. The maximum size and shape are determined by the camera lens system.

In practice, the size of the cells is a direct function of the distance of the camera from the surface of the pelt. The image recorded in each cell should be focused identically to the image of any other cell in the grid, because the camera is held at a constant distance and with constant lighting, generally, no adjustments are required in the shutter aperture. As understood by one highly skilled in the art, exceptions may be made to produce special, optical effects in the finished, artificial pelt. Such exceptions are beyond the scope of this discussion and the following claims.

Considering FIG. 6A as an arbitrary example of a grid for the master image file for a zebra. Based on measurements of the pelt, the maximum width 608 of the pelt is approximately 80 inches (about 203 cm) and the maximum length-nose to tail—is about 120 inches (about 303 cm). Assuming the maximum cell dimension the camera can photograph is 20×20 inches (about 51×51 cm. The dimensions of the grid are simply determined as: the number of rows 604 equals length 120 divided by maximum length of a cell, 20 inches equals 120/20=6. Similarly, the number of columns 605 is maximum width 80 divided by width of a cell 20, or 80/20=4.

The specimen pelt is positioned below the lens of the camera so that the center of focus of the lens is aligned precisely, vertically on the center point of cell 1, for example. A single image that covers the full (20×20 in) area of the cell is recorded as the image file for cell 1. The specimen pelt is moved longitudinally such that the center of focus is aligned with the center point 611 of cell 8. The specimen pelt is moved longitudinally again so that the center of focus is aligned with the center point of cell 9, and so on until the center of focus is aligned with the center point 613 of cell 24. Next the specimen pelt is moved laterally so that the focus point of the camera is aligned with the center point 614 of cell 23, then to the center point cell 18, until following this pattern of moving the specimen, the center of focus is on the center point 616 of cell 21 to take the final picture, thereby also creating the final file from which the master image file will be assembled. After the initial positioning of the camera, the specimen pelt is moved either longitudinally a distance equal to the length dimension of a cell or laterally a distance equal to the width of a cell.

Although species vary, the head area of the specimen presents potential challenges in achieving a fully life-like artificial pelt. The general shape of the head, represented differently in FIG. 1A versus and 1B and by cells 2,3,6, and 7 in FIG. 6A varies with the species. The head, commonly the skull, jaw bones, and uppermost part of the spine, comprises the face (mouth, eyes, nose, and muzzle, ears, forehead, and crown of the head to the base of the skull/neck plus unique coat patterns, such as the mane of the male lion or “beard of the male goat”.

The manner in which the head area is presented in the specimen pelt also significantly affect photographing of the head area and must be adapted to produce a life-like artificial pelt. It is generally anticipated that the head area is flattened in the specimen pelt as suggested by FIGS. 1A and 1B and by cells 2,3,6, and 7 in FIG. 6. Each of these examples illustrates a generalized head area, with FIG. 6 suggesting the most general “head area.” If the head area of the specimen is flattened, then the head area of the resulting artificial pelt will be flattened. The flattened presentation of the head area is anticipated, but not absolutely required in producing an artificial pelt. With the flattened head area, all images of the full specimen pelt are made from the same vertical position above the pelt at a common distance from the specimen pelt. The texture, color, and related attributes of the pelt are a result of dying of the flocked material and the use of other fiber materials, e.g. faux hair or real hair, for certain parts of the pelt as well as other materials for eye lids, lips, and the nose. Life-like, artificial pelts based on a specimen pelt with a flattened head are used for a wide array of merchandise, from upholstery to bedding and decorative wall coverings to a variety of formal clothing, including ladies' gowns and coats.

If the head of the specimen pelt is mounted using a mounting form or insert to provide shape and support and a resulting life-like appearance, an art and science of the master taxidermist. The basic procedure and process of producing photo-images to be transferred to the flocked material that is the simulated pelt. With the use of a head mold or insert, the head in part is elevated above the plane of the body and leg segments of the pelt. The distance of the camera from the pelt must be adjusted repeatedly to maintain the critical focus and maintain common dimensions for cells in the photo grid (FIG. 6). Because the shape changes are commonly at sharp angles, relatively smell sections of any cell will be in sharp focus, and multiple images may be required from which only small sections of the head are suitably focused. Focusing and maintaining common image dimension become critical and to some extent a matter of trial and error. However, the claimed system may be adapted to produce an artificial pelt the head of which can be mounted over a support or insert similar to the actual pelt prepared by a taxidermist; however, it appears to be practically impossible to produce an artifical pelt for this purpose starting with a flattened head.

Even using highly sophisticated equipment, less than 100 percent of the field shares the same critical focus. Up to about 20 percent of the field is not in focus compared with the rest of the image. Usually the perimeter of the image is out of focus compared with the central portion. This is a product of lens optics and cannot be entirely avoided, but the problem can be remedied.

For example, in a 20×20 inches cell, an area 16×16 inches, about 64 percent of the total area will be in critical focus, so in determining the grid, assuming the same focus overall dimensions of FIG. 6. Of 80×120 inches, rows 604 would be 16 inches and the number of rows would be 120/16=7.5, and in practice fractions are rounded up, so that eight rows would be required., rather than six. Similarly, for the columns 605, 80/16=5. Five rows would be required rather than four. The resulting grid would comprise 40 cells, rather than 24.

FIG. 6B illustrates the above, starting with the same grid as in FIG. 6A and following the same numbering with new numbering only for elements not shown or noted in FIG. 6A. FIG. 6A shows the results of making 20×20 images and utilizing only a 16×16 center area for each.

FIG. 6B shows all 24 cells of FIG. 6A. Each cell is numbered 602 in the upper left hand corner, as in FIG. 6A. The perimeter lines of the central portion, 80 percent (the only portion in FIG. 6A, are relatively light, but for cells, 7,11,15, and 19, are readily distinguishable. For each of these four cells, the potentially poorly focused area is limited by the outer perimeter of a 20×20 inch cell that is shown by a dense a broken, dense line 617, and the inner boundary (or perimeter) of this poorly focused area is defined and described by the solid line comprising the four sides of the center area of each cell. In practice, the center area of the cell is referred to as the “live” area, because it becomes part of the ultimate master image file. The poorly focused, perimeter areas are commonly designated as “bleed” areas, suggesting poor or weak optical quality (poor focus).

Considering cells 7,11,15, and 19 it is evident that the bleed areas over lap. Other bleed areas, and in some instances a bleed area may overlap a live area. The most obvious illustration simply of the live and bled areas is cell 7 where the top live area 7A overlaps part of the live area of cell 2; similarly, the left side bleed area 7D overlaps part of the live area of cell 8 and cell 9.

Following completion of the photo-imaging of the specimen pelt, every file (image) is critically examined and a first step in synthesis of the master image file is cropping each file to remove all bleed areas, but only bleed areas and editing images to correct photographic defects. The edited files are merged electronically using sophisticated software well known to skilled professionals in the field, to yield the master image file.

The quality of the individual images of the specimen pelt and the master image file can be no better than the digital photographic equipment used to record them and the experience and the professional expertise exercised in every step of producing the individual images and the master image file. This requirement extends to the computer system, including sophisticated photo (image) editing software, as well as a specimen subject support table that allows the specimen pelt to be precisely positioned on the surface and moved precisely as required by the grid to be established. Obviously, it must include a stable camera mount, and shadow free sources of light of appropriate quality (color) and intensity. One skilled in the art recognizes that in some circumstances, the floor may be an appropriate support table.

A suitable, adjustable table is generally available from technical suppliers, or custom manufactured for a specific photo system. A wide variety of camera mounts is available, and lighting is available through numerous speciality outlets. The camera must have superior lens, both grinding and glass quality. The lens in conjunction with a proper shutter system should allow images (total area) of about 20×20 inches, by way of example, not limitation, with uniform, precise focus in a live region of at least 60 percent of the field. Lens speed is not critical, except it must be adequate to provide appropriate depth of field for images in the live area. The resolution of the electronic “film” must be fine enough to reproduce the subject matter images maintaining the sharp, critical focus. Generally fine grain, 300 pixels per square inch is adequate and recognized as the industry standard. It should be noted that detail that is not detectable by normal human vision, such as microscopic detail, is not a concern in evaluating individual images or in the master image file and subsequent reproduction using sublimation dyeing techniques with flocked materials.

The next step is reviewing and evaluating all photographic files and selecting a set to be merged into a single image of the specimen and editing the final file. At this point, the photographic file comprises the entire specimen, but only those parts of the specimen to be reproduced by flocking (commonly less than the entire body) are completed with respect to the final image. Any photographic color corrections, photographic flaws, or flaws that can be corrected photographically are corrected (edited).

At this stage, those areas or segments of the specimen not reproduced by flocking technology, but included as part of the full, final image, are added to the final, life-size image FIG. 1B. As appropriate for the species, these may include the eye slits 104 (discussed above), the mane and the tail 105 and 106, respectively (discussed above). Finally, those areas designated as the three pairs of perimeter sections: the lateral edges 106A/B, the ventral shoulder sections 106C/D, and the posterior sections 106E/F.

The next step is to produce the master image file that will be transferred to the flocked material. This process is well known to those of professional level skills in computer graphics and photography. With what is effectively a life-size, high resolution digital image to be transferred to the transfer material and then to the flocked material completed, the next step is the photo-thermal process using dye sublimation technology in which colors, including shades and “depth” in the final image are transferred to the flocked material; as discussed in more detail below, this is a time consuming reiterative process to achieve the ultimate, life-like simulation. Although the layer of flocking material is very thin (fine), the image created has life-like three dimensional characteristics.

Generally, the texture of both members of all three pairs of perimeter sections 106A-F is similar if not the same. Commonly these areas are uniform in color with little pattern development of differentiation. The long pile material is colored before it is threaded or otherwise attached to the specific areas on the flocked material. Applying the long pile texturing material may be done either by carefully scraping flocking from the flocked material and attaching the long pile to the smoothed area, or by using the area on the flocked material as a template, outlining the six areas to be textured with long pile material on material suitable for applying the long pile material and appropriate for being connected along the boundary lines (108A-108F), applying the long pile material and stitching (or otherwise connecting) the material to the flocked material. Generally, the line of attachment is slightly indistinct, with a slight fringe of flocked material encroaching the long pile boundary lines. Like the flocking, the long pile produces a unique texture appropriate for the natural texture of the coat in the six specific areas.

It should be noted that the size (width, length is rarely limiting) of the flocked material, in the photography steps, the six perimeter sections may be separately photographed repeatedly to yield separate files for each area, and these files can be printed, dyed or pre-dyed, then carefully trimmed and used as templates for texturing. In some instances, a body segment, such as in ears, may be photographed and separate files produced for each ear. In this case, the ears are flocked material like the rest of the core body; however, the separate files of each ear can be edited and the orientation of the grain of the flocking (which simulates the natural grain of the coat) can be modified on each, separate ear. These ears in the merged file photograph are carefully removed in the ultimate print, and the more realistic ears with more normal grain are directly attached.

Ensuring the desired, life-like appearance of eye lids, mane, and other comparable areas requires considerations of at least three factors: the size and shape of the specific, individual area and the use of an appropriately textured material. Frequently such areas are not dyed, so that on the flocked and dyed material, the specific areas are readily identified, cut-out, and used as a template for the final product. Faux hair material as well as real hair are appropriate for a variety of uses such as ears. In other instances, mane, tail, and eye slits, specific parts are individually produced. Detailed examples of ears, eye lids, mane, and the tail follow. One skilled in the art recognizes that other body parts or areas may require special manufacture as a function of the specimen and potentially unique commercial demands, such as including claws in felines.

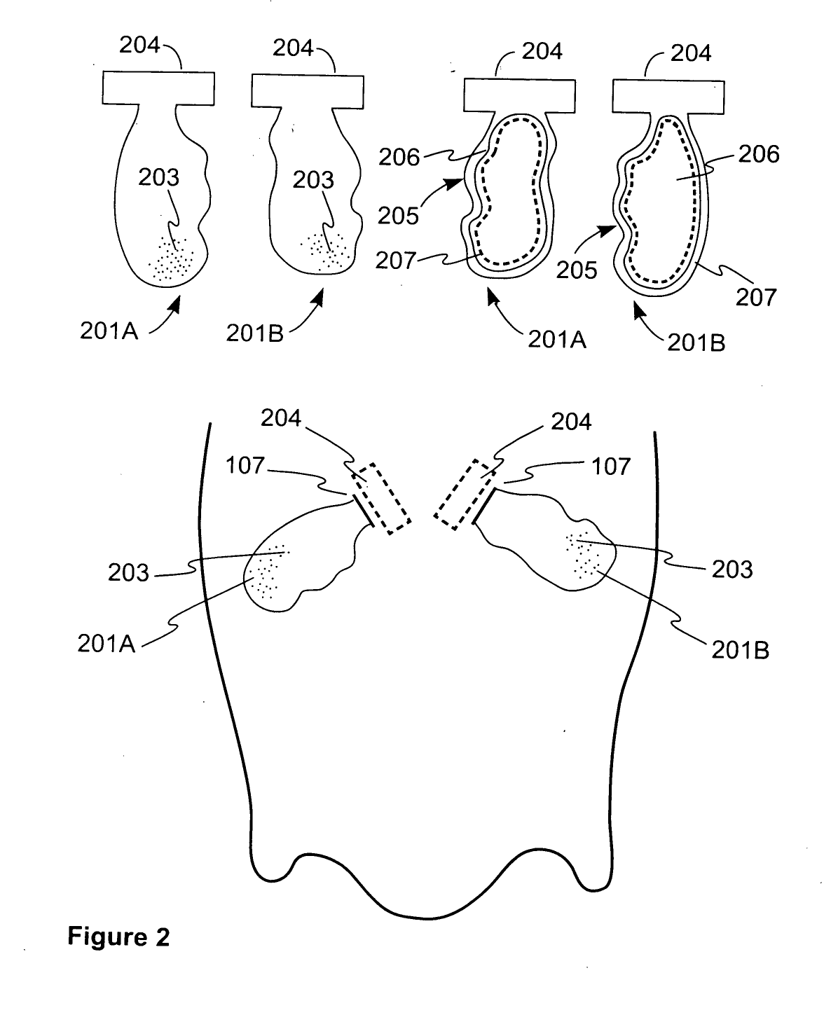

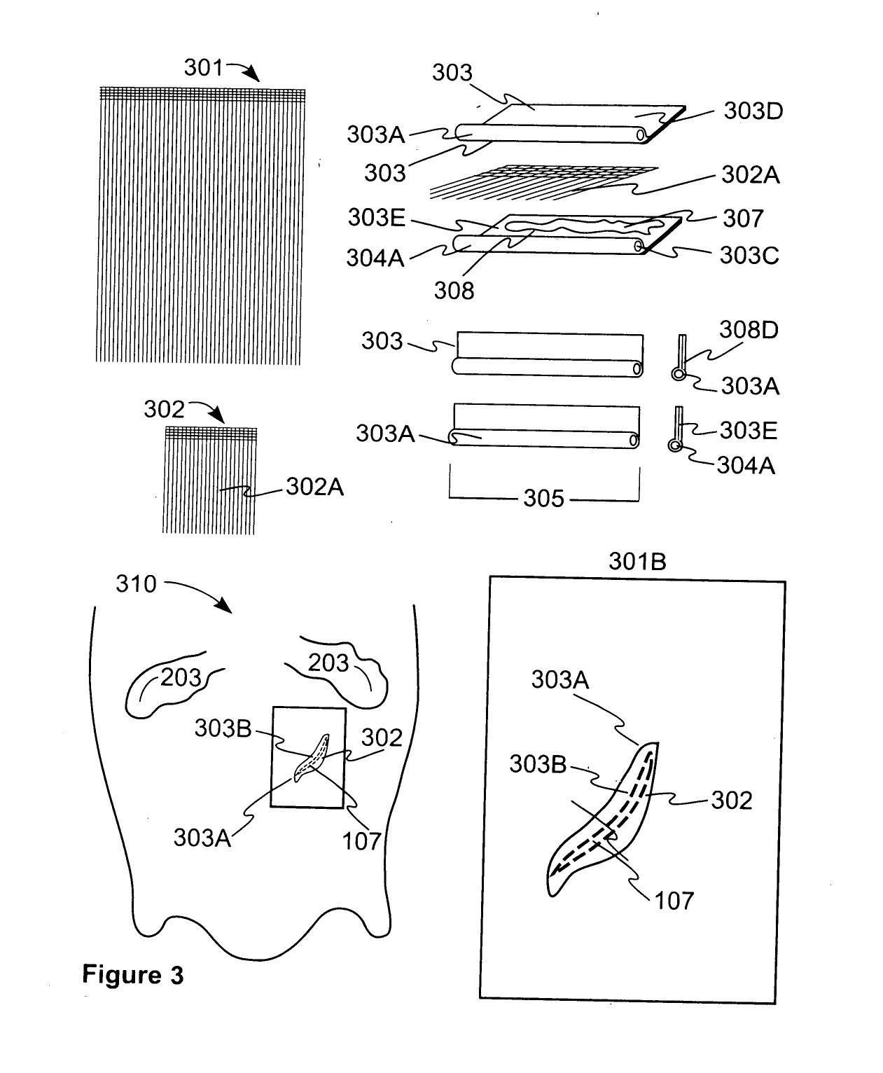

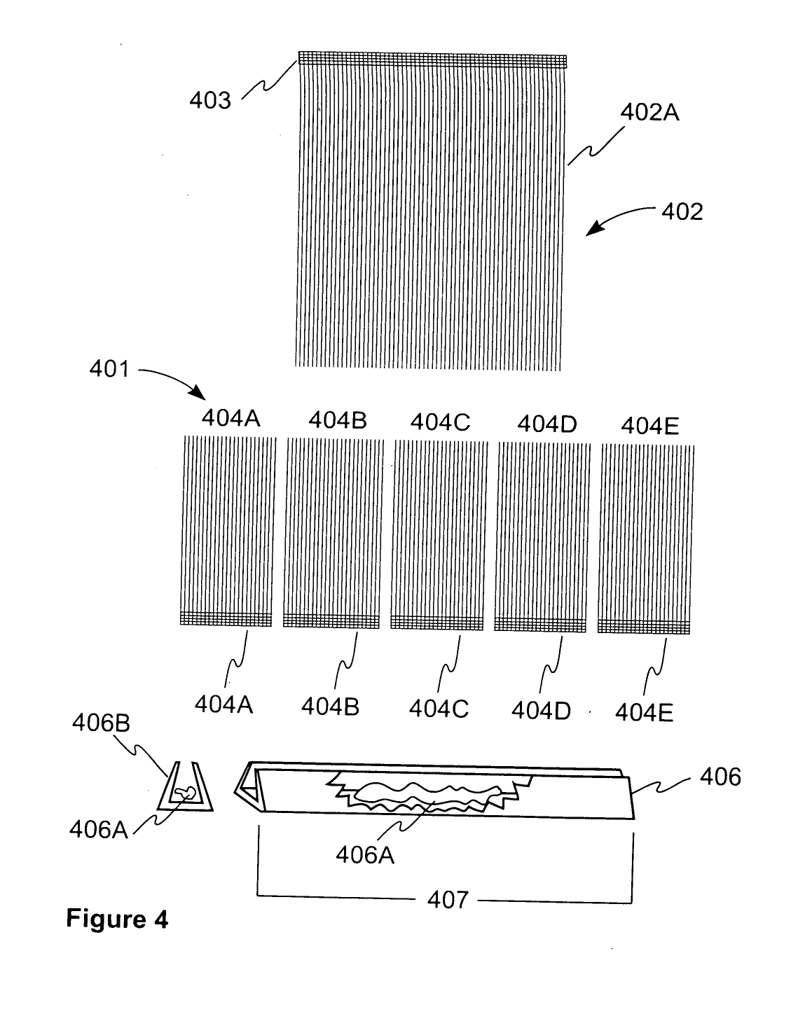

In the following examples, FIG. 2 (ears), FIG. 3 (eye slits and lashes), and FIG. 4 (mane, with an application for tails, too), the zebra pelt is a preferred example because of its unique, but widely recognized coat pattern and because it is suitable to illustrate ears, eye slits, mane, and tail. FIG. 1A should be consulted in relation to FIGS. 2,3, and 4.

With respect to the zebra, the image of each of the ear flaps is carefully cut from the completed flocked sheet 101A as the first step in producing the ear flap assembly. Separate images are a part of the photographing sublimation dyeing steps. These images are trimmed to a pre-existing ear flap template that includes a connector tab 204. The ear flap further includes appropriately flocked and dyed elements (each members of a pair of ear flaps 201A and 201B, each has a flocked face 203 and reverse (inner) side 205 of the flap). Area designated 206 is an inner ear liner for each ear and ear flap margins 207 allows rolling the perimeter of each ear flap to the liner, providing a realistic appearance not possible with traditional, two-dimensional simulations. The connector tab 204 is connected to the underside of the flocked sheet using an appropriate adhesive or invisible stitching to complete the assembly.

The eyelid and eyelash assembly FIG. 3 comprises a detail that contributes a significant element of life-like character to the completed, simulated pelt, or products produced from it. The assembly comprises two elements: hair weft, real or artificial hair that is selected for appropriate color (frequently dark) and texture (not unusually fine and fairly stiff). The appropriate hair is selected and sown together to form the hair weft 301. The hair weft 301 is thinned with appropriate shears and trimmed to a proper length and density 302 based on observations made on the specimen and additional of the characteristics of the species.

Next, simulated eyelids that will provide the foundation for the eyelashes are formed from synthetic or real leather, FIG. 3. The material is light and flexible. Color depends on the specimen, but commonly it varies from light brown to black, and is commonly uniform in color. The leather material is known in the industry as welting 303. One edge 303A of the leather welting material 303 is folded or wrapped around welting cord to form a tube-like structure. The welting material including the welting cord 305C is cut into relative short segments 305 depending on the specimen (0.75 to 1.50 inches or 1.80 to 3.60 cm). The trimmed weft 302 is positioned between two pieces of the leather welting 303D and 303E, with the hair (eyelashes) 302A extending outward from the rolled edge 304 of the leather welting material 303. An appropriate adhesive 307 is spread on opposing faces of the two pieces of the leather welting such that the hair weft is secured between them. The connecting tabs 308 extending opposite the rolled edge is inserted into the eye slit 107 on the flocked material and the rolled material 304 properly positioned prior to being secured to the flocked material.

Positioning of the eye lid/eye lash assembly is best understood by reference to the head section 310. The natural coat pattern makes identification of the eye slits 107 difficult. The ear flaps are shown in outline form 203 for reference/positioning purposes and a centerline of the head indicated by arrows labeled c/1 is also shown for reference/positioning purposes. The general area surrounding the eye, including the eye slit 107 is set-off; see 301A. An exploded view of box, 301B provides detail of the inserted, properly positioned eyelid/eyelash assembly. The connecting tab 308 for each eyelid/eyelash assembly (each eye) is inserted into the eye slit 107 and the rolled edges 303A and 304A positioned along the upper and lower edges of the slit, with the lashes 302A extending outward. The connecting tab 308 for each is attached to the bottom surface of the flock material by invisible stitching or an appropriate adhesive to complete the positioning of the assembly.

One method to complete the mane hair assembly 401 is illustrated in FIG. 4. The initial steps are very similar to the initial steps described for the manufacture of the eyelid/eyelash assembly. Hair wefts 402A having the desired texture, thickness, and color are selected and cut into pieces of varying 404A,B,C,D, and E according to the color changes of the specimen pelt, e.g. along the mane line 105 (FIG. 1). The length of each hair weft 405A-E varies according to the coat pattern.

The individual hair wefts 402A are positioned in sequence in a plastic extrusion 406 the length 407 of which is slightly longer than the a narrow slit cut along the line of the mane on the flocked material. Glue 406A is spread in the extrusion 406 (cut away view) and end view 406B and the extrusion is positioned in the slit and secured by an adhesive or invisible stitching to complete the mane hair assembly 402.

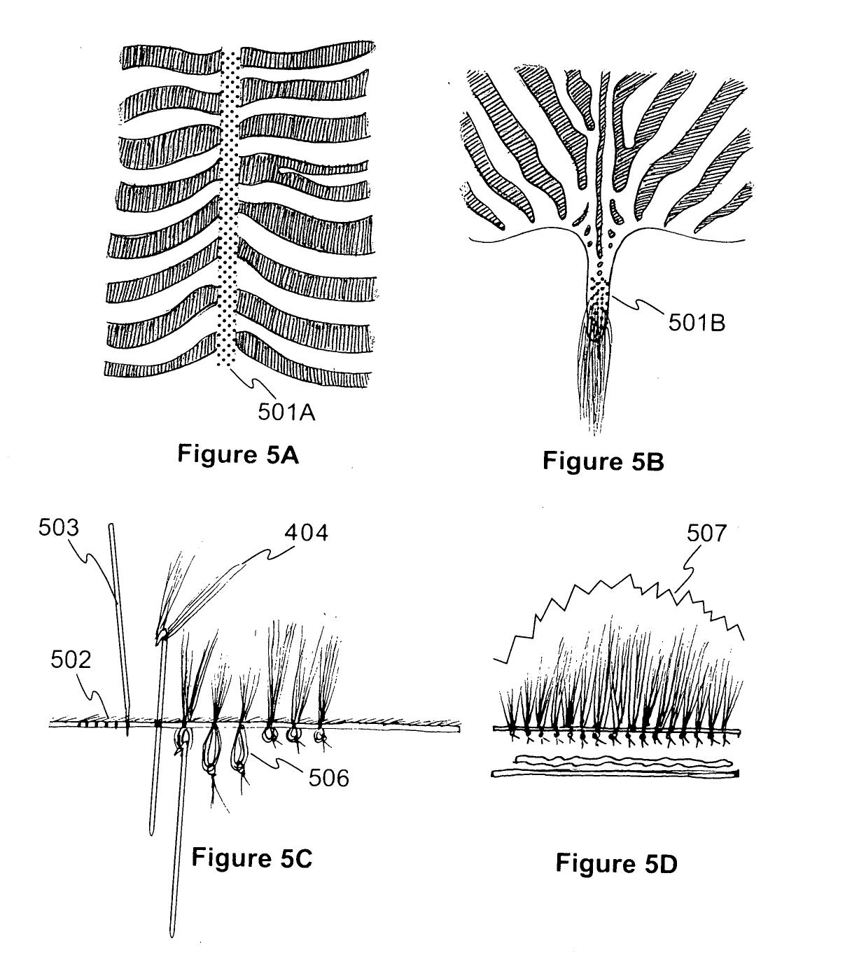

In an alternative to the hair wefts and plastic extrusion, either real or artificial hair (synthetic fibers) for mane hair and long hair on the tail of some animals is used, FIG. 4. The process can be described in four steps and is effectively the same for the mane or tail. As illustrated in FIGS. 5A and 5B, along the mane line 501A or the tail 501B a closely (densely) packed array of very small holes 502 is punched through the flocked material and several hairs of selected color and texture are pulled through each hole 502 using a fine weaving hook 503 to pull a loop of hair downward through the hole and secured on the inside face of the flocked material. The loop may be secured with a small piece of light string 506 or a drop of glue. It is then pulled upwards to its maximum length. The full mane or tail is trimmed, line 507, when hair has been secured in effectively every hole 5D.

As noted above, eye slits, mane, and tail elements, as appropriate are assembled and appropriately attached to the flocked material. The final step is carefully and critically trimming the full sized, dye sublimated, flocked material image, completing any final touch-up/repairs with appropriate coat material, and cleaning and dressing the finished, simulated pelt. Depending on the ultimate use of this product, a final finishing step of attaching a color coordinated backing may be included.

I claim:

1. A method of producing a high quality, life-like, simulated animal pelt comprising:
selecting a specific animal, including gender;
securing a high quality specimen of the pelt of said specific animal;
preparing said specimen pelt for high resolution photography;
producing a comprehensive digital photographic array (set of files) comprising at least one suitable view all sections of said specimen pelt and representing said entire specimen pelt;
editing and grouping the members of said photographic array (set of files) of said specimen pelt and merging appropriate views to produce a single detailed, high quality, life-like image of said specimen pelt;
transferring said single, detailed high quality, life-like/life-size image of said specimen pelt to a photo-thermal, sublimation dye sensitive transfer material;
securing a flocked material with flock particles appropriate for desired dyeing and adhesive appropriate to a selected base material for an intended end use of the simulated pelt.
using photo-thermal, dye-sublimation methods and technology, transfer said image from said transfer material to said flocked material;
cutting and reassembling the final image the body of said specimen pelt into a final image requiring only morphological details to be secured to it;
manufacturing from said flocked image ear flaps and securing them to the final image of said body as appropriate for the specimen selected, and manufacturing and attaching as appropriate eye slits, nose elements and lips; and
finally adding other texturing materials to areas intentionally not flocked to enhance the appearance of the finished simulated, life-like animal pelt.

2. A life-like, high quality simulated, animal pelt produced following the method of claim 1.

3. A life-like, high quality, simulated, animal pelt produced following the method of claim 1 wherein, the specimen animal pelt is a pelt of any canine species.

4. A life-like, high quality, simulated, animal pelt produced following the method of claim 1, wherein, the specimen animal pelt is a pelt of any feline species.

5. A life-like, high quality, simulated, animal pelt produced following the method of claim 1, wherein, the specimen pelt is a pelt of any non-domestic, ungulate species.

6. A life-like, high quality, simulated, animal pelt produced following the method of claim 1, wherein the specimen pelt is a pelt of any domestic ungulate species.

7. A life-like, high quality, simulated, animal pelt produced following the method of claim 1, wherein, the specimen pelt is a pelt of any domestic mammal.

8. A life-like, high quality, simulated animal pelt produced following the method of claim 1, wherein the specimen pelt is a pelt of any animal recognized in the United States as a big game animal and for which a hunting season has been established in at least one State.
